(19) United States
(12) Patent Application Publication
(10) Pub. No.: US 2026/0262133 A1
(43) Pub. Date: Sep. 3, 2026

(54) ENHANCED SIDELINK CSI-RS TRANSMISSIONS FOR BEAM MEASUREMENT

(71) Applicant: Apple Inc., Cupertino, CA (US)

(72) Inventors: Chunxuan Ye, San Diego, CA (US); Ankit Bhamri, Bad Nauheim (DE); Dawei Zhang, Saratogo, CA (US); Hong He, San Jose, CA (US); Wei Zeng, Saratogo, CA (US); Weidong Yang, San Diego, CA (US)

(21) Appl. No.: 19/164,806

(22) PCT Filed: Mar. 29, 2024
(86) PCT No.: PCT/US2024/022290

§ 371 Date: Sep. 12, 2025

Related U.S. Application Data
(60) Provisional application No. 63/456,234, filed on Mar. 31, 2023.

(51) Int. Cl. H04W 76/40; H04W 72/25; H04W 76/14

(52) U.S. Cl. CPC H04W 76/40; H04W 72/25; H04W 76/14

(57) ABSTRACT

Disclosed are methods, systems, and computer-readable medium to perform operations including establishing respective sidelink unicast sessions with a plurality of receiver (Rx) user equipment (UEs); establishing a sidelink groupcast session with at least two of the plurality of Rx UEs; causing transmission, via the sidelink groupcast session, of a sidelink Channel State Information-Reference Signal (CSI-RS) to the at least two Rx UEs; and receiving sidelink beam reporting that is separately sent from the at least two Rx UEs via the corresponding unicast sessions of the at least two Rx UEs.

This application claims priority to U.S. Provisional Application No. 63/456,234, filed on Mar. 31, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

One aspect of the subject matter described in this specification may be embodied in a method that involves establishing respective sidelink unicast sessions with a plurality of receiver (Rx) user equipment (UEs); establishing a sidelink groupcast session with at least two of the plurality of Rx UEs; transmitting, via the sidelink groupcast session, a sidelink Channel State Information-Reference Signal (CSI-RS) to the at least two Rx UEs; and receiving sidelink beam reporting that is separately sent from the at least two Rx UEs via the corresponding unicast sessions of the at least two Rx UEs.

The previously described implementation is implementable using a method; a non-transitory, computer-readable medium storing computer-readable instructions to perform the method; one or more processors configured to perform the method; a user equipment (UE) including processing circuitry configured to cause the UE to perform the method; a computer memory interoperably coupled with a hardware processor configured to perform the method or the instructions stored on the non-transitory, computer-readable medium. These and other embodiments may each optionally include one or more of the following features.

In some implementations, establishing the sidelink groupcast session with at least two of the plurality of Rx UEs involves establishing the sidelink groupcast session in response to detecting at least one triggering condition.

In some implementations, the at least one triggering condition includes at least one of: (i) a number of respective sidelink unicast sessions being greater than a first predetermined threshold, (ii) a number of prior CSI-RS transmissions on the respective sidelink unicast sessions within a specified duration being greater than a second predetermined threshold, and (iii) a Channel Busy Ratio (CBR) of the channel on which the respective sidelink unicast sessions operate being greater than a third predetermined threshold.

In some implementations, establishing the sidelink groupcast session with at least two of the plurality of Rx UEs involves establishing the sidelink groupcast session using higher layer signaling.

In some implementations, transmitting, via the sidelink groupcast session, the sidelink CSI-RS to the at least two Rx UEs involves transmitting the sidelink CSI-RS in a sidelink control information (SCI) message.

In some implementations, the sidelink CSI-RS is indicated by a one-bit field in the SCI message.

In some implementations, the one-bit field is set to a value of 1.

In some implementations, the SCI message is a second stage SCI message, and the method further involves transmitting in a first stage SCI message an indication of a format of the second stage SCI message.

In some implementations, the method further involves linking groupcast identifiers of the groupcast session with respective unicast identifiers of the corresponding unicast sessions of the at least two Rx UEs.

Another aspect of the subject matter described in this specification may be embodied in a method that involves establishing a sidelink unicast session with a transmitter (Tx) UE; establishing a sidelink groupcast session with the Tx UE; receiving a sidelink Channel State Information-Reference Signal (CSI-RS) via the sidelink groupcast session; and reporting a CSI-RS measurement to the Tx UE via the sidelink unicast session.

The previously described implementation is implementable using a method; a non-transitory, computer-readable medium storing computer-readable instructions to perform the method; one or more processors configured to perform the method; a user equipment (UE) including processing circuitry configured to cause the UE to perform the method; a computer memory interoperably coupled with a hardware processor configured to perform the method or the instructions stored on the non-transitory, computer-readable medium. These and other embodiments may each optionally include one or more of the following features.

In some implementations, establishing the sidelink groupcast session with the Tx UE involves establishing the sidelink groupcast session via higher layer signaling.

In some implementations, receiving a sidelink Channel State Information-Reference Signal (CSI-RS) via the sidelink groupcast session involves receiving the sidelink CSI-RS in a sidelink control information (SCI) message.

In some implementations, the sidelink CSI-RS is indicated by a one-bit field in the SCI message.

In some implementations, the one-bit field is set to a value of 1.

In some implementations, the SCI message is a second stage SCI message, and the method further involves receiving a first stage SCI message that includes an indication of a format of the second stage SCI message.

In some implementations, linking groupcast identifiers of the groupcast session with unicast identifiers of the unicast session.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1 illustrates an example communication system that includes sidelink communications, according to some implementations.

FIG. 2A and FIG. 2B illustrate an example groupcast Channel State Information-Reference Signal (CSI-RS) procedure, according to some implementations.

FIG. 3A and FIG. 3B illustrate a periodic sidelink CSI-RS transmission procedure, according to some implementations.

FIG. 4A and FIG. 4B illustrate an example semi-persistent sidelink CSI-RS transmission procedure, according to some implementations.

FIGS. 5A, 5B, and 5C illustrate example medium access control (MAC) control elements (CEs) used in semi-persistent CSI signaling, according to some implementations.

FIG. 6A and FIG. 6B illustrate flowcharts of example methods, according to some implementations.

FIG. 7A and FIG. 7B illustrate flowcharts of example methods, according to some implementations.

FIG. 8 illustrates an example user equipment (UE), according to some implementations.

FIG. 9 illustrates an example access node, according to some implementations.

### DETAILED DESCRIPTION

Recently, the wireless communication industry, e.g., in Third Generation Partnership Project (3GPP) proposals, has begun developing solutions for sidelink beam management. These solutions include solutions for sidelink initial beam-pairing, beam maintenance, and beam failure recovery. One solution that has been introduced for beam maintenance is a sidelink Channel State Information (CSI) Reference Signal (CSI-RS) framework. In the proposed framework, CSI acquisition is performed aperiodically on a unicast link between a transmitter (Tx) user equipment (UE) and a receiver (Rx) UE.

The proposed framework has shortcomings, however. One shortcoming manifests when a Tx UE establishes many sidelink unicast sessions with different Rx UEs. Under the proposed framework, each unicast session operates independently of the other sessions. Thus, CSI-RS transmissions on the unicast links are independent of one another, which can lead to inefficiencies. Because each unicast session operates independently, the CSI-RS transmissions for the Tx UE require significant resources, e.g., a dedicated CSI-RS transmission for each unicast session. Additionally, for signaling efficiency, each CSI-RS transmission typically is accompanied by a data transmission (e.g., a Physical Sidelink Shared Channel [PSSCH] transmission). In the scenario where the Tx UE has many unicast sessions, however, the Tx UE may not have sufficient data transmissions to communicate on all of the unicast sessions. This can result in inefficient CSI-RS signaling, and in some cases may prevent or delay the CSI-RS signaling. This is especially true if the CSI-RS is used for beam training purposes, which requires sending multiple CSI-RS on multiple beams. Another shortcoming of the proposed framework is that it only supports aperiodic CSI-RS signaling.

This disclosure describes methods and systems for enhanced sidelink CSI solutions that, among other things, address the shortcomings of the proposed framework. For example, the disclosed methods and systems resolve the signaling inefficiencies in the proposed framework. As described in more detail below, the enhanced sidelink CSI solutions include a groupcast based CSI-RS framework in which a groupcast communication from the Tx UE triggers unicast CSI reporting from a plurality of Rx UEs that have established unicast sessions with the Tx UE. Additionally, the enhanced sidelink CSI solutions include support for periodic and semi-persistent sidelink CSI signaling. Periodic CSI signaling refers to CSI signaling that occurs at a specified periodicity. Semi-persistent CSI signaling refers to CSI signaling that occurs at a specified periodicity, but that has a start time (also called activation time) and an end time (also called release time).

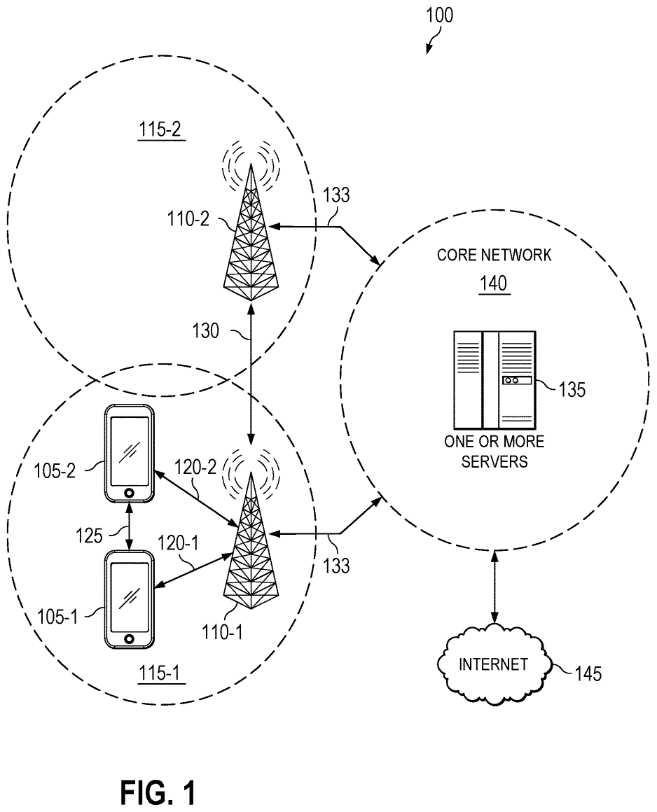

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi networks, and the like. Furthermore, other types of communication standards are possible, including future 3GPP systems (e.g., Sixth Generation (6G)) or the like. While aspects may be described herein using terminology commonly associated with 5GNR, aspects of the present disclosure can be applied to other systems, such as 4G and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI payloads/contents are separated into 2 parts or stages, that is, SCI stage 1 and SCI stage 2. The SCI stage 1 is carried in PSCCH and the SCI stage 2 is carried in PSSCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (Tx UE), and the UE receiving the communication is referred to as a receiver UE (Rx UE). For example, UE 105-1 may be a Tx UE and UE 105-2 may be an Rx UE. Although FIG. 1 illustrates a single Tx UE communicating with a single Rx UE, a Tx UE may communicate with more than one Rx UE via sidelink.

In some implementations, a Tx UE that is initiating sidelink communication may determine the available resources (e.g., sidelink resources) and may select a subset of these resources to communicate with an Rx UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the Tx UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the communication system 100 supports a groupcast CSI-RS procedure on the sidelink 125. The UEs 105 are configured to use the groupcast CSI-RS procedure in scenarios where a Tx UE has a plurality of established unicast sessions with a plurality of Rx UEs. In this procedure, the Tx UE establishes a groupcast session with the plurality of Rx UEs. Then, the Tx UE uses groupcast communication to trigger sidelink CSI reporting from at least one of the plurality of Rx UEs.

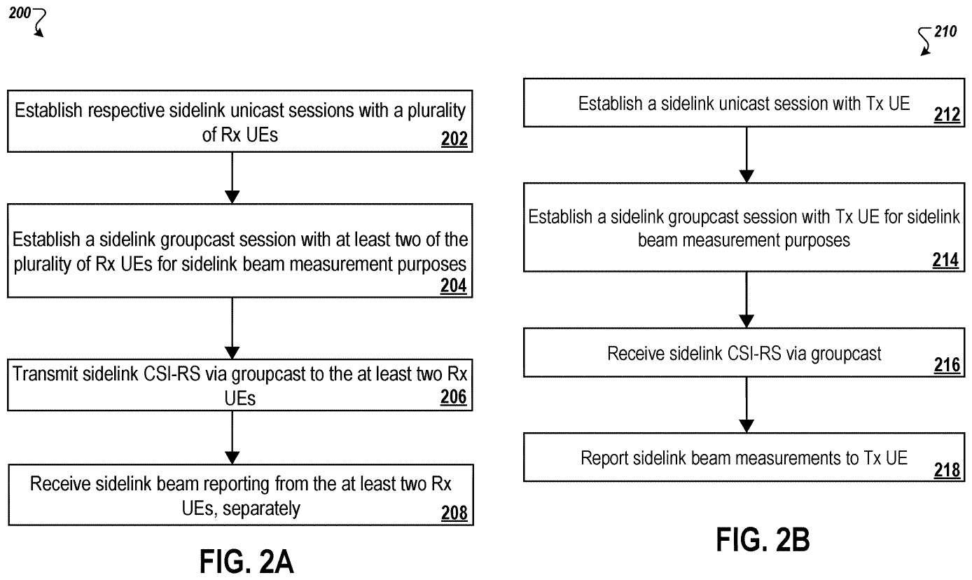

FIG. 2A and FIG. 2B illustrate an example groupcast CSI-RS procedure, according to some implementations. FIG. 2A illustrates a Tx UE procedure 200 in the groupcast CSI-RS procedure. And FIG. 2B illustrates an Rx UE procedure 210 in the groupcast CSI-RS procedure.

Starting with the Tx UE procedure 200, at step 202 the Tx UE establishes respective sidelink unicast sessions with a plurality of Rx UEs. In this example, the Tx UE establishes a first unicast session with a first Rx UE (UE1) and a second unicast session with a second Rx UE (UE2). Note that the first and second unicast sessions can be established at different times. Also note that the Tx UE can establish unicast sessions with more than two Rx UEs.

In some implementations, the Tx UE determines a Source ID

$$( {S}_{1}^{x} )$$

### and a Destination ID

$$( {S}_{2}^{x} )$$

for a unicast session “x” when establishing that unicast session. In this example, the Tx UE determines that the first unicast session has a Source ID

$$( {S}_{1}^{1} )$$

### and Destination ID

$$( {S}_{2}^{1} ) ,$$

and that the second unicast session has a Source ID

$$( {S}_{1}^{2} )$$

### and Destination ID

$$( {S}_{2}^{2} ) .$$

The Source ID and the Destination ID for a particular unicast session are collectively referred to as the unicast IDs for that session. Note that the Tx UE will have different Source IDs for the different unicast sessions.

At step 204, the Tx UE establishes a sidelink groupcast session with at least two of the plurality of Rx UEs for sidelink beam measurement purposes. In this example, the Tx UE establishes a sidelink groupcast session with UE1 and UE2. The Tx UE can establish the sidelink groupcast session using higher layer signaling with the at least two Rx UEs. When establishing the groupcast session, the Tx UE generates a Source ID

$$( {S}_{0}^{G} )$$

and a Destination ID (D^{G}) for the groupcast session. The Source ID and the Destination ID for the groupcast session are collectively referred to as the groupcast IDs.

In some implementations, the Tx UE is configured to establish the groupcast session with the at least two Rx UEs in response to one or more triggering conditions. Within examples, the one or more triggering conditions include: (i) determining that a number of unicast sessions is greater than a predetermined threshold, (ii) determining that a number of sidelink CSI-RS transmissions on the unicast sessions within a specified duration is greater than a predetermined threshold, and/or (iii) determining that a Channel Busy Ratio (CBR) of the channel on which the unicast sessions operate is greater than a predetermined threshold.

In some implementations, the Tx UE links the groupcast IDs and the unicast IDs of the at least two Rx UEs. In this example, the Tx UE links the groupcast IDs and the unicast IDs of the unicast sessions of UE1 and UE2. Linking the groupcast IDs and the unicast IDs may involve associating the IDs with one another. Doing so allows the Tx UE to identify the at least two Rx UEs from which the Tx UE is to expect a beam measurement in response to a beam measurement trigger in the groupcast session.

At step 206, the Tx UE transmits a sidelink CSI-RS via a groupcast communication to the at least two Rx UEs. The groupcast communication triggers the at least two Rx UEs (or a subset of the at least two Rx UEs) to report beam measurements, e.g., measurements of the CSI-RS, to the Tx UE. In this example, the Tx UE transmits the sidelink CSI-RS via a groupcast communication to UE1 and UE2. The sidelink CSI-RS triggers UE1 and/or UE2 to report a measurement of the sidelink CSI-RS. The measurement of the sidelink CSI-RS can serve as a measurement of the beam on which the CSI-RS is transmitted.

In some implementations, the Tx UE transmits the sidelink CSI-RS together with SCI on the groupcast session. Specifically, in a first stage SCI of format 1-A, the Tx UE transmits an indication of the format of the 2nd-stage SCI. Here, a value of 00 indicates SCI format 2-A and a value of 10 indicates SCI format 2-C. Then, in either SCI format 2-A or SCI format 2-C, the Tx UE includes in afield called “CSI request,” an indication (e.g., a value “1”) whether the CSI-RS transmission triggers the sidelink unicast beam reporting.

At step 208, the Tx UE receives sidelink beam measurement reporting from the at least two Rx UEs, separately via their respective unicast sessions. In this example, the Tx UE receives beam measurement reporting from UE1 and UE2 via the first unicast session and the second unicast session, respectively.

Turning to FIG. 2B, the procedure 210 is performed by each of the at least two Rx UEs, e.g., UE1 and UE2. At step 212, the Rx UE establishes a unicast session with the Tx UE. During establishment of the unicast session, each Rx UE determines a Source ID

$$( {S}_{2}^{x} )$$

### and a Destination ID

$$( {S}_{1}^{x} ) ,$$

where “x” is the unicast session index or the UE number. For example, UE1 determines a Source ID

$$( {S}_{2}^{1} )$$

### and a Destination ID

$$( {S}_{1}^{1} )$$

for the unicast session with the Tx UE. And UE2 determines a Source ID

$$( {S}_{2}^{2} )$$

### and a Destination ID

$$( {S}_{1}^{2} )$$

for the unicast session with the Tx UE.

At step 214, the Rx UE establishes a sidelink groupcast session with the Tx UE for sidelink beam measurement purposes. During establishment of the groupcast session, the Rx UE determines a Source ID

$$( {S}_{x}^{G} )$$

and the Destination ID (D^{G}) for the groupcast session. For example, UE1 determines a Source ID

$$( {S}_{1}^{G} )$$

for the groupcast session, and UE2 determines a Source ID

$$( {S}_{2}^{G} )$$

for the groupcast session. Note that the Destination ID (D^{G}) is common amongst all devices. Further, the Rx UEs are configured with information that a CSI-RS transmission on groupcast is equivalent to a CSI-RS transmission on unicast session #x.

At step 216, the Rx UE receives a CSI-RS from the Tx UE via a groupcast communication. As explained previously, the Tx UE can communicate the CSI-RS using SCI on the groupcast session. At step 218, the Rx UE reports sidelink beam measurements to the Tx UE via the corresponding sidelink unicast session with the Tx UE. For example, UE1 reports sidelink beam measurements to the Tx UE on the first unicast session, and UE2 reports sidelink beam measurements to the Tx UE on the second session.

In some implementations, the communication system 100 is configured to support periodic and/or semi-persistent sidelink CSI-RS transmissions. In these implementations, the UEs 105 are configured with a mechanism for periodic sidelink CSI-RS transmission and/or with a mechanism for semi-persistent sidelink CSI-RS transmission. In some examples, the communication system 100 may provide the UEs 105 with instructions on the type of CSI-RS transmission to use. In other examples, the UEs 105 are configured to use periodic sidelink CSI-RS transmission in certain scenarios and semi-persistent sidelink CSI-RS transmission in other scenarios. In yet other examples, the UEs 105 are (pre)configured to use only one of the CSI-RS transmission types, perhaps per resource pool.

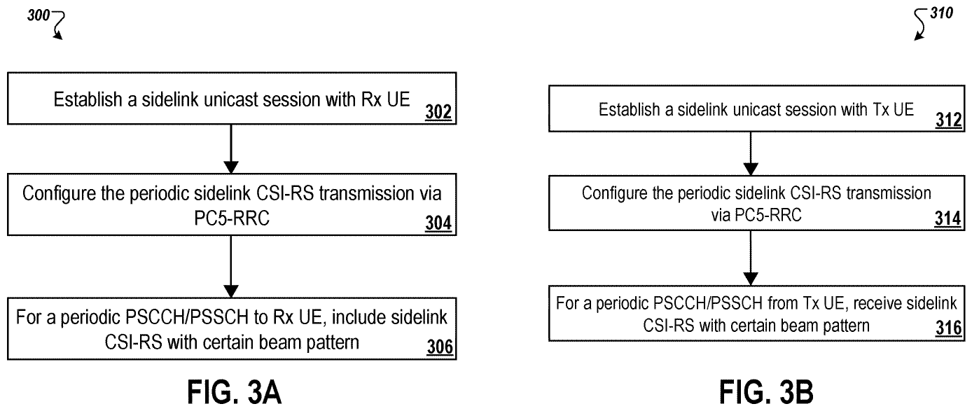

FIG. 3A and FIG. 3B illustrate an example periodic sidelink CSI-RS transmission procedure, according to some implementations. FIG. 3A illustrates an example Tx UE procedure 300 for periodic sidelink CSI-RS transmissions. And FIG. 3B illustrates an example Rx UE procedure 310 for periodic sidelink CSI-RS transmissions.

Starting with the Tx UE procedure 300, at step 302, the Tx UE establishes a sidelink unicast session with an Rx UE. At step 304, the Tx UE configures with the Rx UE via PC5-RRC a periodic CSI-RS configuration. For example, the periodic CSI-RS configuration can be included in the PC5-RRC configuration exchanged with the Rx UE. In some implementations, the periodic CSI-RS configuration includes an indication of one or more CSI-RS resources. In some examples, each CSI-RS resource includes a periodicity and/or a beam direction of the CSI-RS transmitted in that CSI-RS resource. The periodicity can be one of a set of values configured per resource pool, can have units of milliseconds or slots, and can serve as an indication of whether the particular CSI-RS is periodic or semi-persistent. The beam direction can indicate whether the beam for the CSI-RS resource is Quasi-Co-Located (QCL) with a sidelink synchronization signal block (S-SSB). Alternatively, the beam direction can directly indicate the beam index for the CSI-RS resource.

At step 306, the Tx UE includes a CSI-RS in a periodic data transmission (e.g., PSCCH/PSSCH) transmitted to the Rx UE with a certain beam pattern. More specifically, after the periodic CSI-RS configuration is created, the Tx UE selects periodic PSCCH/PSSCH resources (for carrying CSI-RS) with a periodicity according to the configured CSI-RS periodicity. In some scenarios, the periodic CSI-RS configuration may include more than one periodic CSI-RS resource. The Tx UE is configured with one or more options for selecting resources in these scenarios. In a first option, the Tx UE is configured to select multiple periodic PSCCH/PSSCH resources, each having the same periodicity as the corresponding configured CSI-RS resource. In a second option, if the same periodicity is configured on all CSI-RS resources, then the Tx UE is configured to select a single periodic PSCCH/PSSCH resource, where multiple CSI-RS transmissions can occur within each PSCCH/PSSCH transmission.

Turning to the Rx UE procedure 310, at step 312, the Rx UE establishes a unicast session with the Tx UE. At step 314, the Rx UE configures with the Tx UE via PC5-RRC a periodic CSI-RS configuration. At step 316, the Rx UE receives a CSI-RS with a certain beam pattern in a periodic PSCCH/PSSCH from the Tx UE. In response to receiving the CSI-RS, the Rx UE performs a beam measurement.

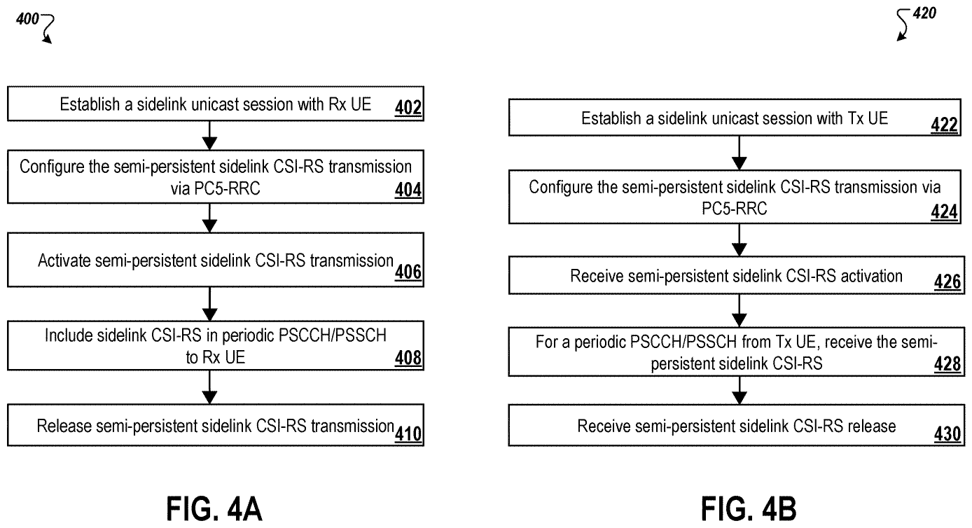

FIG. 4A and FIG. 4B illustrate an example semi-persistent sidelink CSI-RS transmission procedure, according to some implementations. FIG. 4A illustrates an example Tx UE procedure 400 for semi-persistent CSI-RS transmissions. And FIG. 4B illustrates an example Rx UE procedure 420 for semi-persistent CSI-RS transmissions. Semi-persistent CSI transmissions refer to CSI-RS transmissions that occur at a specified periodicity, but that have a start time (also called activation time) and an end time (also called release time). Accordingly, the semi-persistent sidelink CSI-RS transmission procedures are similar to the periodic sidelink CSI-RS transmission procedures but also include an activation time and a release time.

Starting with the Tx UE procedure 400, at step 402, the Tx UE establishes a sidelink unicast session with an Rx UE. At step 404, the Tx UE configures with the Rx UE via PC5-RRC a semi-persistent CSI-RS configuration. For example, the Tx UE can include the semi-persistent CSI-RS configuration in the PC5-RRC configuration exchanged with the Rx UE. Similar to the periodic CSI-RS configuration, one or more sidelink CSI-RS resources are configured in the semi-persistent CSI-RS configuration.

At step 406, the Tx UE activates the semi-persistent CSI-RS transmission. In some implementations, the Tx UE uses an activation message to activate the semi-persistent CSI-RS transmission. The type of activation message can be specified in the semi-persistent CSI-RS configuration. Within examples, the activation message can be an SCI or a MAC CE. That is, the activation can be SCI based activation or MAC CE based activation.

In some implementations, if the activation type is an SCI based activation, the semi-persistent CSI-RS configuration specifies that an SCI activates semi-persistent CSI-RS transmissions. In these implementations, the semi-persistent configuration specifies that a single bit in SCI stage 1 or SCI stage 2 indicates activation of a CSI-RS resource. The SCI, whether stage 1 or stage 2, also includes a field that specifies an identifier of the activated CSI-RS resource.

In some implementations, if the activation type is a MAC CE based activation, the semi-persistent configuration specifies that a MAC CE activates semi-persistent CSI-RS transmissions. In these implementations, the MAC CE can include one or more CSI-RS resource identifiers. In examples where the MAC CE includes a plurality of CSI-RS resources identifiers, the MAC CE can simultaneously activate a plurality of CSI-RS resources.

In some implementations, the semi-persistent configuration also includes an activation timing configuration. In some examples, the activation timing is a fixed period (e.g., 3 milliseconds [ms]) or a configurable period after the acknowledgement message (ACK) to the activation message. In these examples, the activation timing can be configured per resource pool or per PC5-RRC (i.e., each pair of UEs determines its own configuration). In some examples, the activation timing is specified in the activation message (e.g., MAC CE or SCI).

At step 408, the Tx UE transmits a CSI-RS in a periodic PSCCH/PSSCH to the Rx UE. This step is similar to step 306 of FIG. 3A. For example, similar to the periodic CSI-RS operation, the Tx UE in this step selects a periodic PSCCH/PSSCH that matches the periodicity of the CSI-RS specified in the semi-persistent CSI-RS configuration.

At step 410, the Tx UE releases the semi-persistent CSI-RS transmission. In some implementations, the Tx UE releases the semi-persistent CSI-RS transmission in response to a release condition specified in the semi-persistent CSI-RS configuration. Within examples, the release condition can be based on: (i) a total activation duration, (ii) a threshold amount of time from activating the semi-persistent CSI-RS transmission, or (iii) a threshold number of CSI-RS transmissions.

In some implementations, the Tx UE uses a release message to release the semi-persistent CSI-RS transmission. The type of message can be specified in the semi-persistent CSI-RS configuration. Within examples, the release message can be an SCI or a MAC CE. That is, the release can be SCI based release or MAC CE based release. The format of the release MAC CE may be the same or different format as the activation MAC CE. If the format is the same, then a bit in the MAC CE can indicate whether the MAC CE is for activation or release.

In some implementations, the semi-persistent configuration also includes a release timing configuration. In some examples, the release timing is a fixed period (e.g., 3 ms) or a configurable period after the acknowledgement message (ACK) to the release message. In these examples, the release timing can be configured per resource pool or per PC5-RRC (i.e., each pair of UEs determines its own configuration). In some examples, the release timing is specified in the release message (e.g., MAC CE or SCI).

Turning to the Rx UE procedure 420, at step 422, the Rx UE establishes a sidelink unicast session with Tx UE. At step 424, the Rx UE configures, via PC5-RRC communication with the Tx UE, the semi-persistent CSI-RS configuration. At step 426, the Rx UE receives a semi-persistent CSI-RS activation from the Tx UE. At step 428, the Rx UE receives the semi-persistent sidelink CSI-RS in a periodic PSCCH/PSSCH from the Tx UE. At step 430, the Rx UE receives a semi-persistent sidelink CSI-RS release.

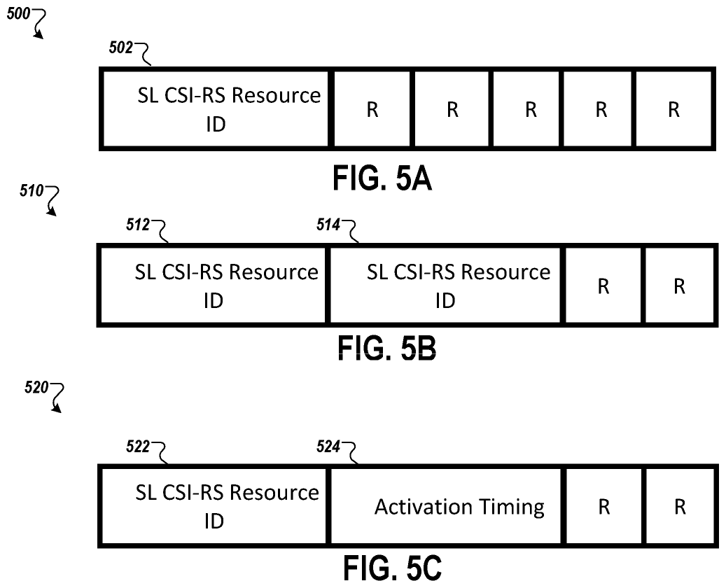

FIGS. 5A, 5B, and 5C illustrate example MAC CEs used in semi-persistent CSI signaling, according to some implementations. FIG. 5A illustrates an example activation MAC CE 500. As shown in FIG. 5A, the MAC CE 500 includes a single sidelink CSI-RS resource ID 502. FIG. 5B illustrates an example activation MAC CE 510. As shown in FIG. 5B, the MAC CE 510 includes a multiple sidelink CSI-RS resource IDs 512, 514. FIG. 5C illustrates an example activation MAC CE 520. As shown in FIG. 5C, the MAC CE 520 includes a sidelink CSI-RS resource ID 522 and an activation timing value 524.

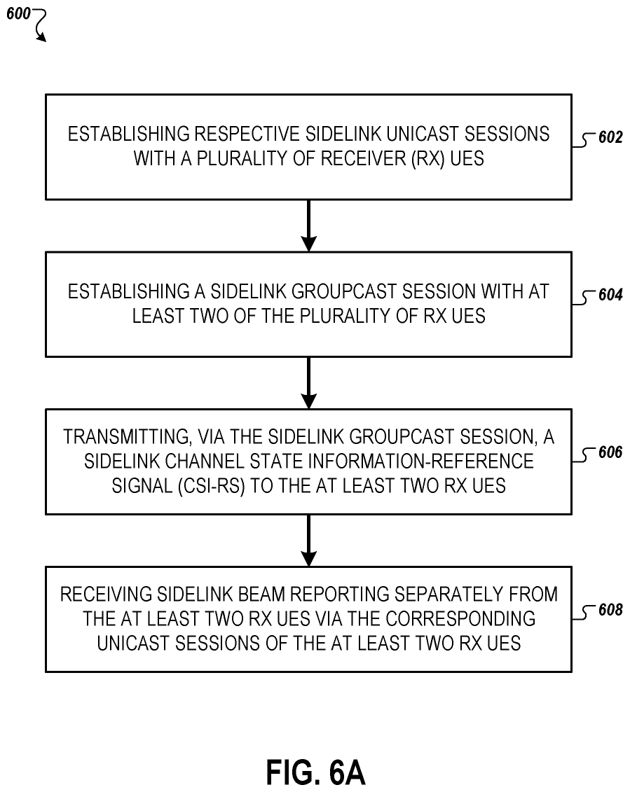

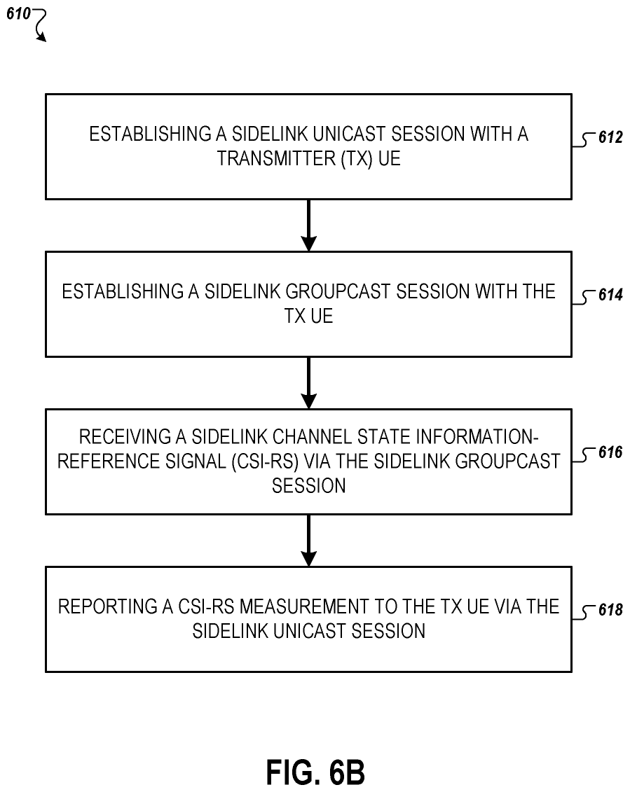

FIG. 6A illustrates a flowchart of an example method 600, according to some implementations. For clarity of presentation, the description that follows generally describes method 600 in the context of the other figures in this description. For example, method 600 can be performed by UEs 105 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order. In some examples, method 600 is performed by a Tx UE.

At step 602, method 600 involves establishing respective sidelink unicast sessions with a plurality of receiver (Rx) UEs.

At 604, method 600 involves establishing a sidelink groupcast session with at least two of the plurality of Rx UEs.

At 606, method 600 involves transmitting, via the sidelink groupcast session, a sidelink Channel State Information-Reference Signal (CSI-RS) to the at least two Rx UEs.

At 608, method 600 involves receiving sidelink beam reporting separately from the at least two Rx UEs via the corresponding unicast sessions of the at least two Rx UEs.

In some implementations, establishing the sidelink groupcast session with at least two of the plurality of Rx UEs involves establishing the sidelink groupcast session in response to detecting at least one triggering condition.

In some implementations, the at least one triggering condition includes at least one of: (i) a number of respective sidelink unicast sessions being greater than a first predetermined threshold, (ii) a number of prior CSI-RS transmissions on the respective sidelink unicast sessions within a specified duration being greater than a second predetermined threshold, and (iii) a Channel Busy Ratio (CBR) of the channel on which the respective sidelink unicast sessions operate being greater than a third predetermined threshold.

In some implementations, establishing the sidelink groupcast session with at least two of the plurality of Rx UEs involves establishing the sidelink groupcast session using higher layer signaling.

In some implementations, transmitting, via the sidelink groupcast session, the sidelink CSI-RS to the at least two Rx UEs involves transmitting the sidelink CSI-RS in a sidelink control information (SCI) message.

In some implementations, the sidelink CSI-RS is indicated by a one-bit field in the SCI message.

In some implementations, the one-bit field is set to a value of 1.

In some implementations, the SCI message is a second stage SCI message, and the method further involves transmitting in a first stage SCI message an indication of a format of the second stage SCI message.

In some implementations, method 600 further involves linking groupcast identifiers of the groupcast session with respective unicast identifiers of the corresponding unicast sessions of the at least two Rx UEs.

FIG. 6B illustrates a flowchart of an example method 610, according to some implementations. For clarity of presentation, the description that follows generally describes method 610 in the context of the other figures in this description. For example, method 610 can be performed by UEs 105 of FIG. 1. It will be understood that method 610 can be performed, for example, by any suitable system, environment, software, hardware, or a combination of systems, environments, software, and hardware, as appropriate. In some implementations, various steps of method 610 can be run in parallel, in combination, in loops, or in any order. In some examples, method 610 is performed by an Rx UE.

At 612, method 610 involves establishing a sidelink unicast session with a transmitter (Tx) UE.

At 614, method 610 involves establishing a sidelink groupcast session with the Tx UE.

At 616, method 610 involves receiving a sidelink Channel State Information-Reference Signal (CSI-RS) via the sidelink groupcast session.

At 618, method 610 involves reporting a CSI-RS measurement to the Tx UE via the sidelink unicast session.

In some implementations, establishing the sidelink groupcast session with the Tx UE involves establishing the sidelink groupcast session via higher layer signaling.

In some implementations, receiving a sidelink Channel State Information-Reference Signal (CSI-RS) via the sidelink groupcast session involves receiving the sidelink CSI-RS in a sidelink control information (SCI) message.

In some implementations, the sidelink CSI-RS is indicated by a one-bit field in the SCI message.

In some implementations, the one-bit field is set to a value of 1.

In some implementations, the SCI message is a second stage SCI message, and method 610 further involves receiving a first stage SCI message that includes an indication of a format of the second stage SCI message.

In some implementations, linking groupcast identifiers of the groupcast session with unicast identifiers of the unicast session.

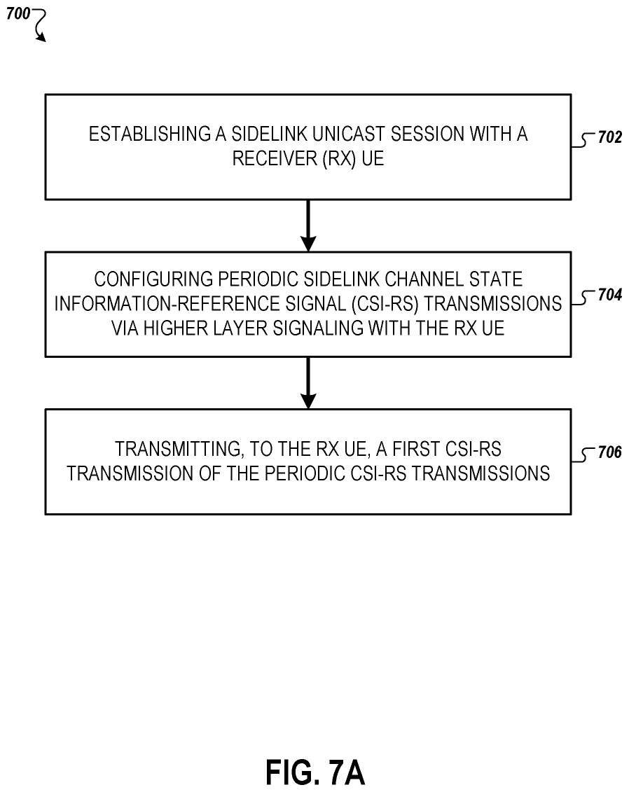

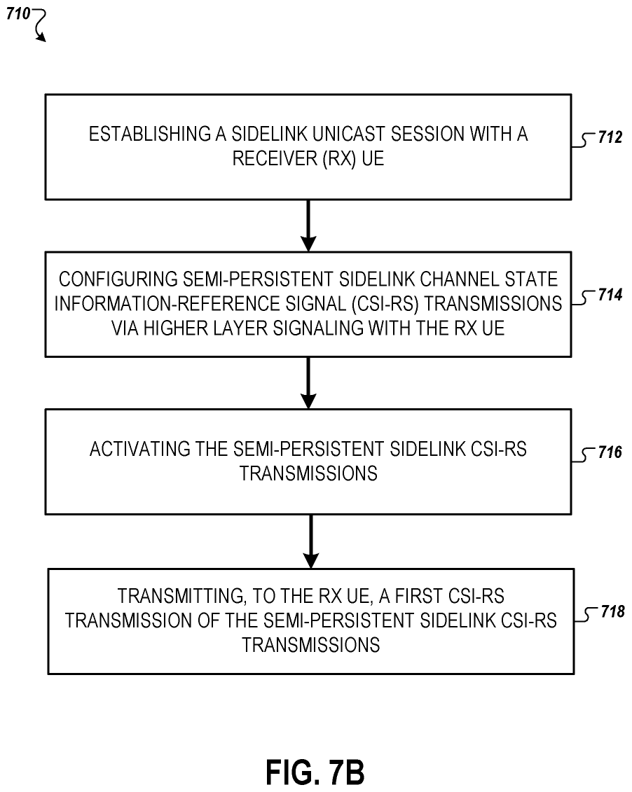

FIG. 7A illustrates a flowchart of an example method 700, according to some implementations. For clarity of presentation, the description that follows generally describes method 700 in the context of the other figures in this description. For example, method 700 can be performed by UEs 105 of FIG. 1. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order. In some examples, method 700 is performed by a Tx UE.

At 702, method 700 involves establishing a sidelink unicast session with a receiver (Rx) UE.

At 704, method 700 involves configuring periodic sidelink Channel State Information-Reference Signal (CSI-RS) transmissions via higher layer signaling with the Rx UE.

At 706, method 700 involves transmitting, to the Rx UE, a first CSI-RS transmission of the periodic CSI-RS transmissions.

In some implementations, the higher layer signaling is PC5-radio resource control (RRC) signaling.

In some implementations, configuring the periodic CSI-RS transmissions involves determining a CSI-RS configuration including one or more sidelink CSI-RS resources for the periodic CSI-RS transmissions.

In some implementations, each of the one or more sidelink CSI-RS resources includes at least one of: (i) a periodicity of that sidelink CSI-RS resource, or (ii) a direction of a beam of that sidelink CSI-RS resource.

In some implementations, the periodicity is selected from a plurality of values that are configured per resource pool.

In some implementations, the beam direction is a beam index or an indication that the beam is quasi-co-located (QCL) with a sidelink synchronization signal block (S-SSB) transmission.

In some implementations, transmitting the first CSI-RS transmission involves selecting a periodic data transmission resource based on the periodicity of a corresponding sidelink CSI-RS resource; and transmitting the first CSI-RS transmission in the periodic data transmission resource.

In some implementations, the one or more sidelink CSI-RS resources are a plurality of sidelink CSI-RS resources, and the method further involves selecting a plurality of periodic data transmission resources for transmitting the CSI-RS transmissions, where each data transmission resource has a periodicity based on a periodicity in a corresponding one of the plurality of sidelink CSI-RS resources.

In some implementations, where the one or more sidelink CSI-RS resources are a plurality of sidelink CSI-RS resources, where the plurality of sidelink CSI-RS resources have the same periodicity, and the method further involves selecting a single periodic data transmission resource for transmitting the CSI-RS transmissions, where more than one sidelink CSI-RS transmission is scheduled in each periodic data transmission.

FIG. 7B illustrates a flowchart of an example method 710, according to some implementations. For clarity of presentation, the description that follows generally describes method 710 in the context of the other figures in this description. For example, method 710 can be performed by UEs 105 of FIG. 1. It will be understood that method 710 can be performed, for example, by any suitable system, environment, software, hardware, or a combination of systems, environments, software, and hardware, as appropriate. In some implementations, various steps of method 710 can be run in parallel, in combination, in loops, or in any order. In some examples, method 710 is performed by a Tx UE.

At 712, method 710 involves establishing a sidelink unicast session with a receiver (Rx) UE.

At 714, method 710 involves configuring semi-persistent sidelink Channel State Information-Reference Signal (CSI-RS) transmissions via higher layer signaling with the Rx UE.

At 716, method 710 involves activating the semi-persistent sidelink CSI-RS transmissions.

At 718, method 710 involves transmitting, to the Rx UE, a first CSI-RS transmission of the semi-persistent sidelink CSI-RS transmissions.

In some implementations, activating the semi-persistent sidelink CSI-RS transmissions involves transmitting an activation message to the Rx UE.

In some implementations, the activation message is a medium access control (MAC) control element (CE) or a sidelink control information (SCI) message.

In some implementations, the activation message includes one or more sidelink CSI-RS resource identifiers.

In some implementations, the activation message includes an activation timing.

In some implementations, method 710 further involves releasing the semi-persistent sidelink CSI-RS transmissions.

In some implementations, releasing the semi-persistent sidelink CSI-RS transmissions involves transmitting a release message to the Rx UE.

In some implementations, the release message is a medium access control (MAC) control element (CE) or a sidelink control information (SCI) message.

In some implementations, the release message includes a release timing.

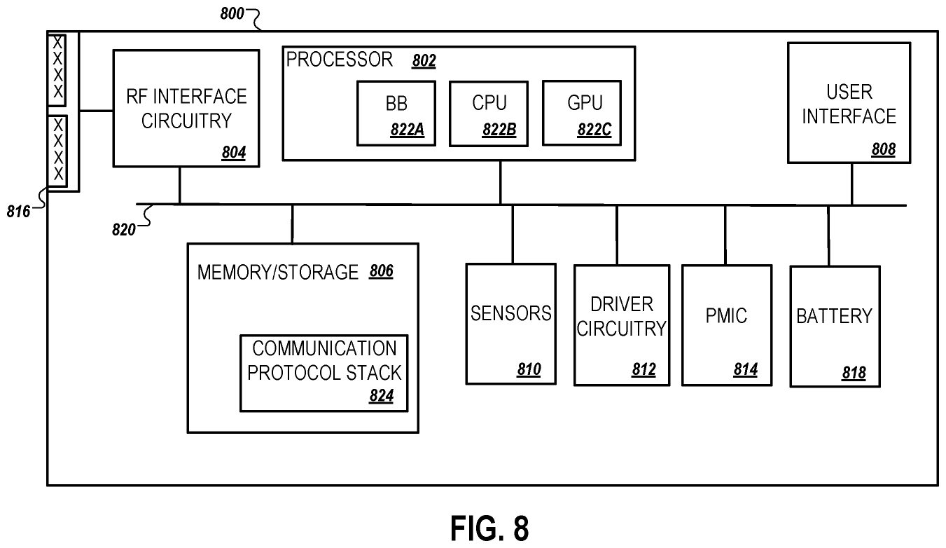

FIG. 8 illustrates an example UE 800, according to some implementations. The UE 800 may be similar to and substantially interchangeable with UEs 105 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processor 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processor 802 may include one or more processors. In particular, the processor 802 may include processor circuitry such as, for example, baseband processor circuitry (BB) 822A, central processor unit circuitry (CPU) 822B, and/or graphics processor unit circuitry (GPU) 822C. The processor 802 may include any type of circuitry or processor circuitry that executes or otherwise operates computer-executable instructions, such as program code, software modules, or functional processes from memory/storage 806 to cause the UE 800 to perform operations as described herein.

In some implementations, the processor 802 is configured to perform operations including establishing respective sidelink unicast sessions with a plurality of receiver (Rx) UEs; establishing a sidelink groupcast session with at least two of the plurality of Rx UEs; causing transmission, via the sidelink groupcast session, of a sidelink Channel State Information-Reference Signal (CSI-RS) to the at least two Rx UEs; and receiving sidelink beam reporting separately from the at least two Rx UEs via the corresponding unicast sessions of the at least two Rx UEs.

In some implementations, the processor 802 is configured to perform operations including establishing a sidelink unicast session with a transmitter (Tx) UE; establishing a sidelink groupcast session with the Tx UE; receiving a sidelink Channel State Information-Reference Signal (CSI-RS) via the sidelink groupcast session; and reporting a CSI-RS measurement to the Tx UE via the sidelink unicast session.

In some implementations, the processor 802 is configured to perform operations including establishing a sidelink unicast session with a receiver (Rx) UE; configuring periodic sidelink Channel State Information-Reference Signal (CSI-RS) transmissions via higher layer signaling with the Rx UE; and causing transmission, to the Rx UE, of a first CSI-RS transmission of the periodic CSI-RS transmissions.

In some implementations, the processor 802 is configured to perform operations including establishing a sidelink unicast session with a receiver (Rx) UE; configuring semi-persistent sidelink Channel State Information-Reference Signal (CSI-RS) transmissions via higher layer signaling with the Rx UE; activating the semi-persistent sidelink CSI-RS transmissions; and causing transmission, to the Rx UE, of a first CSI-RS transmission of the semi-persistent sidelink CSI-RS transmissions.

In some implementations, the processor 802 is configured to perform operations including establishing a sidelink unicast session with a transmitter (Tx) UE; configuring periodic sidelink Channel State Information-Reference Signal (CSI-RS) transmissions via higher layer signaling with the Tx UE; and receiving, from the Rx UE, a first CSI-RS transmission of the periodic CSI-RS transmissions.

In some implementations, the processor 802 is configured to perform operations including establishing a sidelink unicast session with a transmitter (Tx) UE; configuring semi-persistent sidelink Channel State Information-Reference Signal (CSI-RS) transmissions via higher layer signaling with the Tx UE; and receiving, from the Tx UE, a first CSI-RS transmission of the semi-persistent sidelink CSI-RS transmissions.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by the processor 802 to cause the UE 800 to perform various operations described herein. The memory/storage 806 include any type of volatile or non-volatile memory that may be distributed throughout the UE 800. In some implementations, some of the memory/storage 806 may be located on the processor 802 itself (for example, L1 and L2 cache), while other memory/storage 806 is external to the processor 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted or deployed in a fixed location and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

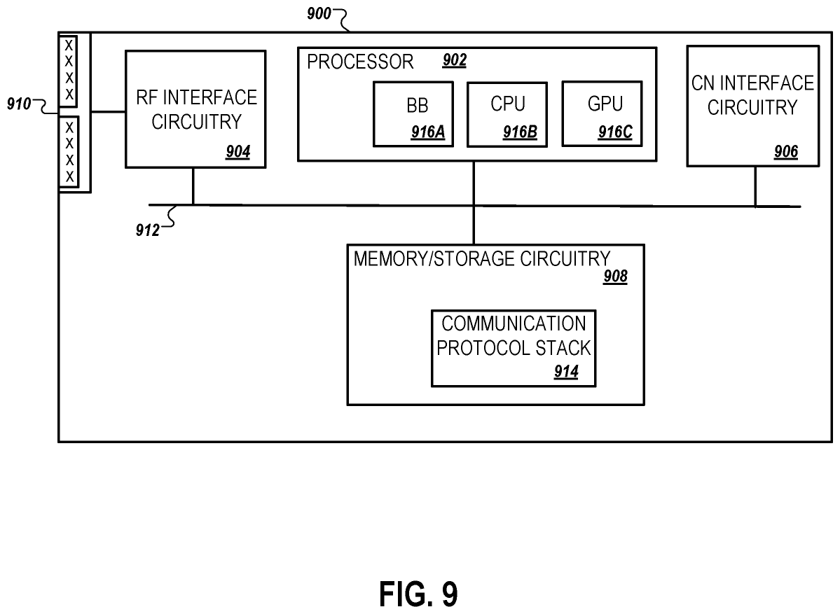

FIG. 9 illustrates an example access node 900 (e.g., a base station or gNB), according to some implementations. The access node 900 may be similar to and substantially interchangeable with base stations 110. The access node 900 may include processor 902, RF interface circuitry 904, core network (CN) interface circuitry 906, memory/storage circuitry 908, and one or more antenna(s) 910.

The components of the access node 900 may be coupled with various other components over one or more interconnects 912. The processor 902, RF interface circuitry 904, memory/storage circuitry 908 (including communication protocol stack 914), antenna(s) 910, and interconnects 912 may be similar to like-named elements shown and described with respect to FIG. 8. For example, the processor 902 may include one or more processors. In particular, the processor 902 may include processor circuitry such as, for example, baseband processor circuitry (BB) 916A, central processor unit circuitry (CPU) 916B, and graphics processor unit circuitry (GPU) 916C. The processor 902 may include any type of circuitry or processor circuitry that executes or otherwise operates computer-executable instructions, such as program code, software modules, or functional processes from memory/storage 908 to cause the access node 900 to perform operations as described herein.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In the following sections, further exemplary embodiments are provided.

Example 1 includes one or more processors configured to perform operations including: establishing respective sidelink unicast sessions with a plurality of receiver (Rx) user equipment (UEs); establishing a sidelink groupcast session with at least two of the plurality of Rx UEs; causing transmission, via the sidelink groupcast session, of a sidelink Channel State Information-Reference Signal (CSI-RS) to the at least two Rx UEs; and receiving sidelink beam reporting that is separately sent from the at least two Rx UEs via the corresponding unicast sessions of the at least two Rx UEs.

Example 2 includes the one or more processors of Example 1, where establishing the sidelink groupcast session with at least two of the plurality of Rx UEs includes: establishing the sidelink groupcast session in response to detecting at least one triggering condition.

Example 3 includes the one or more processors of Example 2, where the at least one triggering condition includes at least one of: (i) a number of respective sidelink unicast sessions being greater than a first predetermined threshold, (ii) a number of prior CSI-RS transmissions on the respective sidelink unicast sessions within a specified duration being greater than a second predetermined threshold, and (iii) a Channel Busy Ratio (CBR) of the channel on which the respective sidelink unicast sessions operate being greater than a third predetermined threshold.

Example 4 includes the one or more processors of Example 1, where establishing the sidelink groupcast session with at least two of the plurality of Rx UEs includes: establishing the sidelink groupcast session using higher layer signaling.

Example 5 includes the one or more processors of Example 1, where causing transmission, via the sidelink groupcast session, of the sidelink CSI-RS to the at least two Rx UEs includes: causing transmission of the sidelink CSI-RS together with a sidelink control information (SCI) message.

Example 6 includes the one or more processors of Example 5, where the sidelink CSI-RS is indicated by a one-bit field in the SCI message.

Example 7 includes the one or more processors of Example 6, where the one-bit field is set to a value of 1.

Example 8 includes the one or more processors of Example 5, where the SCI message is a second stage SCI message, and where the operations further include: causing transmission in a first stage SCI message an indication of a format of the second stage SCI message.

Example 9 includes the one or more processors of Example 1, the operations further including: linking groupcast identifiers of the groupcast session with respective unicast identifiers of the corresponding unicast sessions of the at least two Rx UEs.

Example 10 includes one or more processors configured to perform operations including: establishing a sidelink unicast session with a transmitter (Tx) user equipment (UE); establishing a sidelink groupcast session with the Tx UE; receiving a sidelink Channel State Information-Reference Signal (CSI-RS) that is sent from the Tx UE via the sidelink groupcast session; and reporting a CSI-RS measurement to the Tx UE via the sidelink unicast session.

Example 11 includes the one or more processors of Example 10, where establishing the sidelink groupcast session with the Tx UE includes: establishing the sidelink groupcast session via higher layer signaling.

Example 12 includes the one or more processors of Example 10, where receiving a sidelink Channel State Information-Reference Signal (CSI-RS) via the sidelink groupcast session includes: receiving the sidelink CSI-RS in a sidelink control information (SCI) message.

Example 13 includes the one or more processors of Example 12, where the sidelink CSI-RS is indicated by a one-bit field in the SCI message.

Example 14 includes the one or more processors of Example 13, where the one-bit field is set to a value of 1.

Example 15 includes the one or more processors of Example 12, where the SCI message is a second stage SCI message, and where the operations further include: receiving a first stage SCI message that includes an indication of a format of the second stage SCI message.

Example 16 includes the one or more processors of Example 10, the operations further including: linking groupcast identifiers of the groupcast session with unicast identifiers of the unicast session.

Example 17 may include one or more non-transitory computer-readable media including instructions to cause an electronic device, upon execution of the instructions by one or more processors of the electronic device, to perform one or more elements of the operations described in or related to any of Examples 1-16, or any other method or process described herein.

Example 18 may include an apparatus including logic, modules, and/or circuitry (e.g., processing circuitry) to perform one or more elements of the operations described in or related to any of Examples 1-16, or any other method or process described herein.

Example 19 may include a method, technique, or process as described in or related to any of Examples 1-16, or portions or parts thereof.

Example 20 may include an apparatus including the one or more processors described in or related to any of Examples 1-16, or portions thereof.

Example 21 may include a method of communicating in a wireless network as shown and described herein.

Example 22 may include a system for providing wireless communication as shown and described herein. The operations or actions performed by the system can include the operations of any one of Examples 1-16.

Example 25 may include a device for providing wireless communication as shown and described herein. The operations or actions performed by the device can include the operations of any one of Examples 1-16.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to perform operations comprising:
establishing respective sidelink unicast sessions with a plurality of receiver (Rx) user equipment (UEs);
establishing a sidelink groupcast session with at least two of the plurality of Rx UEs;
causing transmission, via the sidelink groupcast session, of a sidelink Channel State Information-Reference Signal (CSI-RS) to the at least two Rx UEs; and
receiving sidelink beam reporting that is separately sent from the at least two Rx UEs via the corresponding unicast sessions of the at least two Rx UEs.

2. The one or more processors of claim 1, wherein establishing the sidelink groupcast session with at least two of the plurality of Rx UEs comprises:
establishing the sidelink groupcast session in response to detecting at least one triggering condition.

3. The one or more processors of claim 2, wherein the at least one triggering condition comprises at least one of: (i) a number of respective sidelink unicast sessions being greater than a first predetermined threshold, (ii) a number of prior CSI-RS transmissions on the respective sidelink unicast sessions within a specified duration being greater than a second predetermined threshold, and (iii) a Channel Busy Ratio (CBR) of the channel on which the respective sidelink unicast sessions operate being greater than a third predetermined threshold.

4. The one or more processors of claim 1, wherein establishing the sidelink groupcast session with at least two of the plurality of Rx UEs comprises:
establishing the sidelink groupcast session using higher layer signaling.

5. The one or more processors of claim 1, wherein causing transmission, via the sidelink groupcast session, of the sidelink CSI-RS to the at least two Rx UEs comprises:
causing transmission of the sidelink CSI-RS together with a sidelink control information (SCI) message.

6. The one or more processors of claim 5, wherein the sidelink CSI-RS is indicated by a one-bit field in the SCI message.

7. The one or more processors of claim 6, wherein the one-bit field is set to a value of 1.

8. The one or more processors of claim 5, wherein the SCI message is a second stage SCI message, and wherein the operations further comprise:
causing transmission in a first stage SCI message an indication of a format of the second stage SCI message.

9. The one or more processors of claim 1, the operations further comprising:
linking groupcast identifiers of the groupcast session with respective unicast identifiers of the corresponding unicast sessions of the at least two Rx UEs.

10. One or more processors configured to perform operations comprising:
establishing a sidelink unicast session with a transmitter (Tx) user equipment (UE);
establishing a sidelink groupcast session with the Tx UE;
receiving a sidelink Channel State Information-Reference Signal (CSI-RS) that is sent from the Tx UE via the sidelink groupcast session; and
reporting a CSI-RS measurement to the Tx UE via the sidelink unicast session.

11. The one or more processors of claim 10, wherein establishing the sidelink groupcast session with the Tx UE comprises:
establishing the sidelink groupcast session via higher layer signaling.

12. The one or more processors of claim 10, wherein receiving a sidelink Channel State Information-Reference Signal (CSI-RS) via the sidelink groupcast session comprises:
receiving the sidelink CSI-RS in a sidelink control information (SCI) message.

13. The one or more processors of claim 12, wherein the sidelink CSI-RS is indicated by a one-bit field in the SCI message.

14. The one or more processors of claim 13, wherein the one-bit field is set to a value of 1.

15. The one or more processors of claim 12, wherein the SCI message is a second stage SCI message, and wherein the operations further comprise:
receiving a first stage SCI message that includes an indication of a format of the second stage SCI message.

16. The one or more processors of claim 10, the operations further comprising:
linking groupcast identifiers of the groupcast session with unicast identifiers of the unicast session.

17. (canceled)

18. (canceled)

19. A user equipment comprising:
a memory;
a transceiver; and
a processor coupled to the memory and configured to, when executing instructions stored in the memory, cause the UE to:
establishing respective sidelink unicast sessions with a plurality of receiver (Rx) user equipment (UEs);
establishing a sidelink groupcast session with at least two of the plurality of Rx UEs;
causing transmission, via the sidelink groupcast session, of a sidelink Channel State Information-Reference Signal (CSI-RS) to the at least two Rx UEs; and
receiving sidelink beam reporting that is separately sent from the at least two Rx UEs via the corresponding unicast sessions of the at least two Rx UEs.

20. The UE of claim 19, wherein establishing the sidelink groupcast session with at least two of the plurality of Rx UEs comprises:
establishing the sidelink groupcast session in response to detecting at least one triggering condition.

21. The UE of claim 20, wherein the at least one triggering condition comprises at least one of: (i) a number of respective sidelink unicast sessions being greater than a first predetermined threshold, (ii) a number of prior CSI-RS transmissions on the respective sidelink unicast sessions within a specified duration being greater than a second predetermined threshold, and (iii) a Channel Busy Ratio (CBR) of the channel on which the respective sidelink unicast sessions operate being greater than a third predetermined threshold.

22. The UE of claim 19, wherein establishing the sidelink groupcast session with at least two of the plurality of Rx UEs comprises:
establishing the sidelink groupcast session using higher layer signaling.
